(19) United States
(12) Patent Application Publication
(10) Pub. No.: US 2005/0015411 A1
(43) Pub. Date: Jan. 20, 2005

(54) Systems, processes, and products for storage and retrieval of electronic files

(76) Inventor: Gerald Altman, Newton, MA (US)

Correspondence Address: ALTMAN & MARTIN, 6 BEACON ST, STE 600, BOSTON, MA, 02108, US

(21) Appl. No.: 10/914,481

(22) Filed: Aug. 9, 2004

Related U.S. Application Data
(63) Continuation-in-part of application No. 09/665,188, filed on Sep. 17, 2000, now Pat. No. 6,775,422.
(63) Continuation-in-part of application No. 10/667,401, filed on Sep. 23, 2003.
(63) Continuation-in-part of application No. 08/882,833, filed on Jun. 26, 1997, now Pat. No. 6,236,767.
(60) Provisional application No. 60/020,902, filed on Jun. 27, 1996.

(51) Int. Cl. G06F 12/00

(52) U.S. Cl. 707/200

(57) ABSTRACT

A system and process that involve a digital computer storage comprising block locations having physical block addresses and logical block addresses representing a relational database configuration of cells at logical intersections of sequences of rows and columns that specify a sequence of records and a sequence of attributes. A key attribute is a unique identifier that corresponds to the date/time instance of entry of a selected record into the database system. The arrangement is such that a succession of records corresponds to a succession of date/time instances of entry into the database system. This arrangement facilitates selection of a range of electronic records that is outside a range of electronic records that may be subject to hardware or software malfunction or corruption, facilitates the timed periodic storage and destruction of electronic records pursuant to an archive schedule, and reduces storage fragmentation by which seek time delay is reduced.

### CROSS REFERENCE TO RELATED APPLICATIONS

The present application is a continuation-in-part of U.S. application Ser. No. 09/665,188, filed Sep. 17, 2000, and a continuation in part of U.S. application Ser. No. 10/667,401, filed Sep. 23, 2003. Aforementioned application Ser. No. 09/665,188 is projected U.S. Pat. No. 6,775,422, dated Aug. 10, 2004. Aforementioned application Ser. No. 10/667,401 is a continuation-in-part of aforementioned application Ser. No. 09/665,188. Aforementioned application Ser. No. 09/665,188 is a continuation-in-part of U.S. application Ser. No. 08/882,833, filed Jun. 26, 1997, now U.S. Pat. No. 6,236,767, which claims the filing date of U.S. Provisional application No. 60/020,902, filed Jun. 27, 1996. Aforementioned application Ser. Nos. 09/665,188 and 10/667,401 are incorporated herein by reference.

### STATEMENT REGARDING FEDERALLY SPONSORED RESEARCH AND DEVELOPMENT

Not Applicable

### BACKGROUND OF THE INVENTION

1. Field of the Invention

The present invention relates to systems, processes and products for the storage and retrieval of electronic files containing digital records that may be produced in situ or may be received by transmission over local area or wide area networks, or the Internet. Such digital records may constitute electronic representations of all manner of documents, graphics and transactions, including those generated by word processors, electro-optical scanners, digital cameras, and signal processors.

2. The Prior Art

Numerous systems and processes have been proposed for the storage and retrieval of information. Traditional practices, of course, have involved manual storage and retrieval of indexed arrangements of original papers and other physical media. Later practices have involved photographically reducing original papers to indexed miniaturizations in microfilm spools or microfiche sheets, and retrieving images or hard copies of the miniaturizations by optical projection or photographic reproduction.

Now there are a proliferation of proposals for digital computer systems that electronically and opto-electronically store digital records in magnetic disc, optical disc, and magnetic tape media. Demand for electronic storage has grown exponentially, in part because of new government regulations that mandate or permit timed periodic retention and destruction of massive collections of business, legal, medical, and military records and the like.

The storage and retrieval of electronic records are vulnerable to hardware malfunction, software corruption and human error. The foregoing problems are greatly magnified in networked systems, where difficulties may be encountered particularly in standardizing, at disparate locations, the storage and retrieval of electronic documents.

The following semantic distinction will facilitate a discussion and understanding the present invention. (1) Physical things, which include persons, may reside in or may be stored at physical “locations”. Such locations are physical in the sense that the things they contain are directly accessible. (2) On the other hand, electronic records, which include all kinds of electronic representations, may be stored on or retrieved from electronic “locations” on magnetic, optical or other electronic storage media, including dynamic media such as discs and tapes, and solid state configurations such as solid state arrays. Such electronic locations are accessible only electronically, i.e. are not directly accessible. However, such electronic locations are physical in the sense that the electronic representations they contain are actually “blocks” of magnetic configurations or the like.

Block data storage devices store and/or retrieve digital data in the form of blocks that are individually addressable by a host device. Exemplary block data storage devices include magnetic disc drives, optical disc drives, magnetic tape drives, and solid state arrays.

Such block data storage devices typically comprise a hardware/firmware based interface circuit, a communication channel, a recordable medium, a programming control, a servo control, and a read/write head. The interface circuit includes a buffer for the temporary storage of transferred data and a controller in the form of a digital processor that supervises operation of the system The user storage space of the recording medium is divided into a multiplicity of addressable blocks which are assigned host-computer addresses, sometimes referred to as logical block addresses or LBA's. Each LBA has a corresponding physical block address or PBA, which is used by servo control circuitry to align a data transducing head with an appropriate region of the recording medium to access a specified LBA.

To write data to the recording medium, the host computer issues a write command that contains user data to be stored by the storage system, along with a list of LBA's at which the user data are to be stored. The storage system temporarily stores the user data in a buffer, schedules movement of a data transducing head to appropriate positions or PBA's at locations in the storage medium, and transmits appropriately encoded and conditioned user data through a communication channel to write user data to the selected LBA's.

To subsequently read user data from the storage system, the host computer issues a read command identifying the LBA's from which data are to be retrieved. The storage device schedules movement of the data transducing head to appropriate physical locations in the storage medium, and transmits appropriately decoded user data through the communication channel to the buffer for subsequent transfer back to the host computer.

Such host-storage data transfers are typically accomplished through a host interface port that is configured in accordance with an industry standard protocol, such as ATA, SCSI, etc. The controller uses operational programming to manage the overall operation of the system. Programming commands for the controller are typically stored in an integrated circuit memory device that is accessible by the controller during operation. The memory device further typically stores diagnostic programming that allows a user to monitor the operation of the controller and to diagnose error conditions.

### SUMMARY OF THE INVENTION

The object of the present invention is to improve data storage security and accessibility in a block storage system by date/time addressing. A more particular object of the present invention is to provide a digital computer comprising a stack of magnetic discs having block locations at physical intersections of concentric circular tracks and radial sectors and an assemblage of transducers that receive and transmit electronic signals representing records in the block locations, logical block addresses corresponding to the physical block addresses and having a data-type format that is capable of being processed by a controller, the logical block addresses representing a relational database configuration of cells at logical intersections of a sequence of rows and columns that specify a sequence of records and a sequence of attributes, one of the attributes being the date/time instance of entry of the selected record into the database system. The arrangement is such that a succession of records correspond to a succession of date/time instances of entry into the database system.

The arrangement of the present invention: (1) facilitates selection of a succession of a range of electronic records that is outside of a range of electronic records that may be affected by hardware or software malfunction or corruption; (2) facilitates the timed periodic storage and destruction of electronic records pursuant to an archive schedule; and (3) reduces storage fragmentation by which seek time delay is reduced.

### BRIEF DESCRIPTION OF THE DRAWINGS

For a fuller understanding of the nature and objects of the present invention, reference is made to the following specification, which is to be taken in connection with the accompanying drawings wherein:

FIG. 1a is a functional block diagram of a database hardware and software system for processing storage and retrieval of electronic files pursuant to the present invention and FIG. 1b is a block diagram a multi-station implementation of FIG. 1a;

FIG. 2 illustrates a graphical user interface for presentation and control of a database system according to the present invention;

FIG. 3 illustrates another graphical user interface for presentation and control of a database system according to the present invention;

FIG. 4a illustrates Table 1 of the relational database system of FIG. 1;

FIG. 4b illustrates Schedule 1, which lists the specifications of Table 1;

FIG. 5a illustrates Table 2 of the relational database system of FIG. 1;

FIG. 5b illustrates Schedule 2, which lists the specifications of Table 2;

FIG. 6a illustrates Table 3 of the relational database system of FIG. 1;

FIG. 6b illustrates Schedule 3, which lists the specifications of Table 3:

FIG. 7 is a diagram of the relationships among Tables 1, 2 and 3;

FIG. 8 illustrates a Query 1, by which a range of files in the database system of FIG. 1 may be selected;

FIG. 9 illustrates Query 2, by which another range of files in the database of FIG. 1 may be selected;

FIG. 10 illustrates a graphical user interface by which a range of files in the database of FIG. 1 may be restored;

FIG. 11 illustrates a graphical user interface by which a range of files in the database of FIG. 1 may be selected; and

FIG. 12 illustrates the steps of a process of the present invention.

### DETAILED DESCRIPTION OF THE PREFERRED EMBODIMENT

Introduction

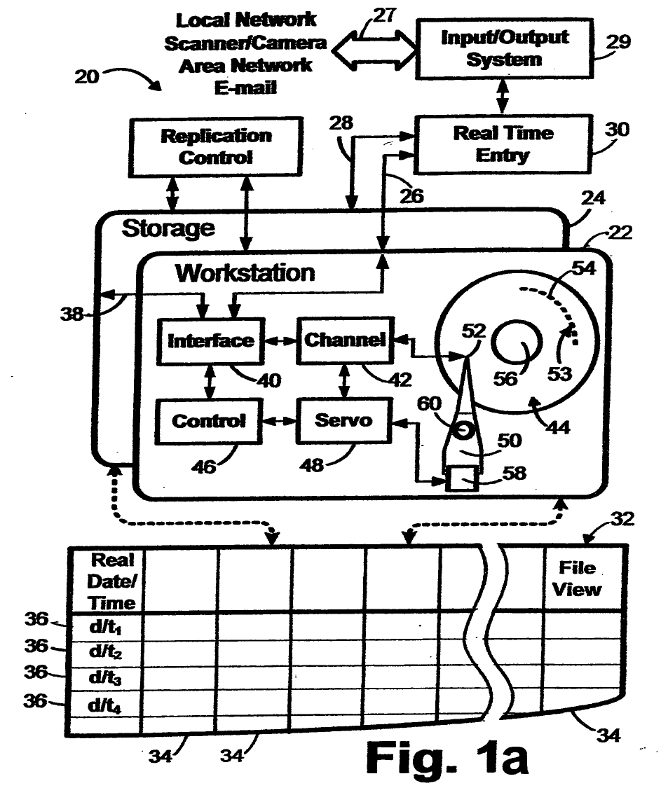

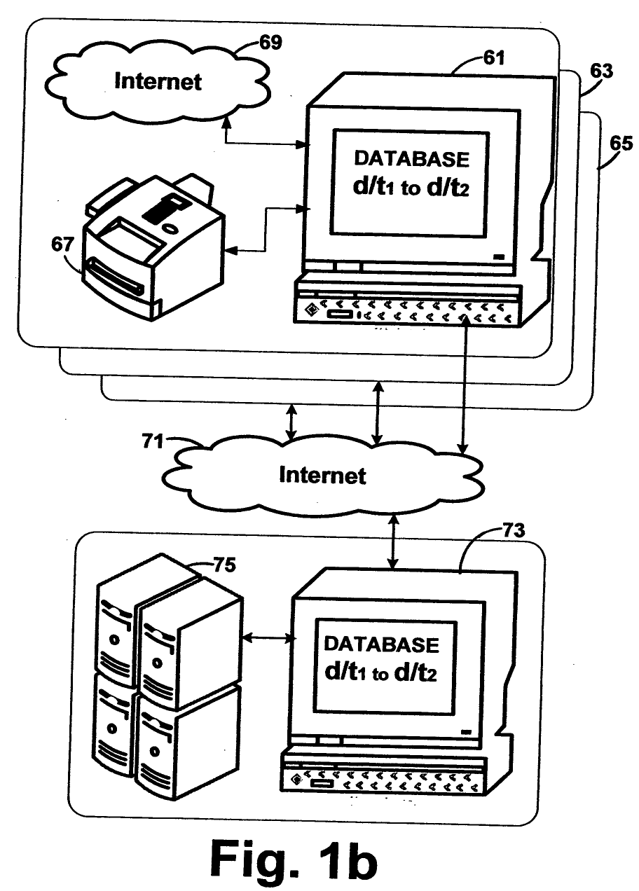

As shown in FIG. 1a, the illustrated embodiment of the present invention comprises a system 20 that includes a host workstation 22 and an auxiliary storage 24. In one embodiment, storage 24 is local backup storage appliance. In another embodiment, storage 24 is a remote backup server on a network. A multiplicity of digital sources 27, as indicated at input/output 29, transmit to and from workstation 22 and storage 24 a random plurality of digital signals 26, 28 through an interface 30. Workstation 22 and storage 24 each includes a magnetic disk system, to be described in greater detail below. These disk systems provide mirrored replicates of a relational database system 32. Database 32, as will be described in greater detail below, comprises a sequence of columns 34 and a sequence of rows 36. Each of rows 36 is an electronic representation of a record that corresponds to a signal or signals that are generated internally by workstation 22 or that are transmitted to workstation 22 from the external sources. With reception of an external signal 26 or generation of a new signal, workstation 22 transmits a corresponding signal via a bus 38 to storage 24. Signals received or generated by workstation 22 are entered as records in database 32 substantially in real time.

As shown in FIG. 1a, each of workstation 22 and storage 24 constitutes a block data storage device that comprises a hardware/firmware based interface circuit 40, a communication channel 42, a stack of recordable magnetic discs 44, a programming control 46, a servo control 48, and an assemblage of transducer arms 50, which swing an assemblage of transducer heads 52 across the upper and lower faces of discs 44. Interface circuit 40 includes a buffer for the temporary storage of transferred data. Control 46 includes a digital processor that supervises operation of the system. The user storage space on each of discs 44 is apportioned into addressable blocks 54, which, as is well known in the art, are (1) distributed along circular tracks that are aligned in geometrical “volumes”, and (2) are grouped about the tracks in geometrical “sectors”. These components are enclosed and supported in a hermetically sealed housing. Also enclosed and supported in the hermetically sealed housing are a spindle motor 56 which rotates the stack of discs 44 at a constant high speed, and an assemblage of actuators 50, which support and position a corresponding assemblage of data transducing heads 52 in contiguity with upper and lower faces of discs 44 for motion across the faces of the discs in an arc about a rotational axis 60. The actuators are stepped about axis 60 by application of current increments to coils 58. Heads 52 store data on and retrieve data from blocks 54 of concentric tracks 53. Further details of workstation 22 and storage 24 are described in: U.S. Pat. No. 6,694,281, Feb. 17, 2004, in the name of Badih M. Arnaout, et al; and U.S. Pat. No. 6,735,678, May 11, 2004, in the name of Gayle L. Noble, et al. These patents are incorporated herein by reference.

As shown in FIG. 1b, a plurality of distributed workstations 61, 63, 65, each of which embodies the associated components of FIG. 1a, are located at plurality of geographical locations. Each is shown as being operatively connected to a multifunction unit 67 and to the Internet 69. Multifunction unit can send and receive faxes and voice messages. These distributed workstations communicate via the Internet, as shown at 71 with a master workstation 73 that controls a massive storage 75. Storage 75 incorporates a disc system that essentially is the same as the disk stystem shown in FIG. 1a. The arrangement is such that all signals received by any of workstations 61, 63, 65 are relayed as corresponding signals in real time to master workstation 73 and massive storage 75.

Blocks 54 are assigned database level addresses, i.e. logical block addresses or LBA's. Each logical block address or LBA has a corresponding physical block address or PBA, which may be in numerical format, and which is used by servo 48 and control 46 to align transducing heads 52 with appropriate locations on a disk 44 in order to access specified LBA's.

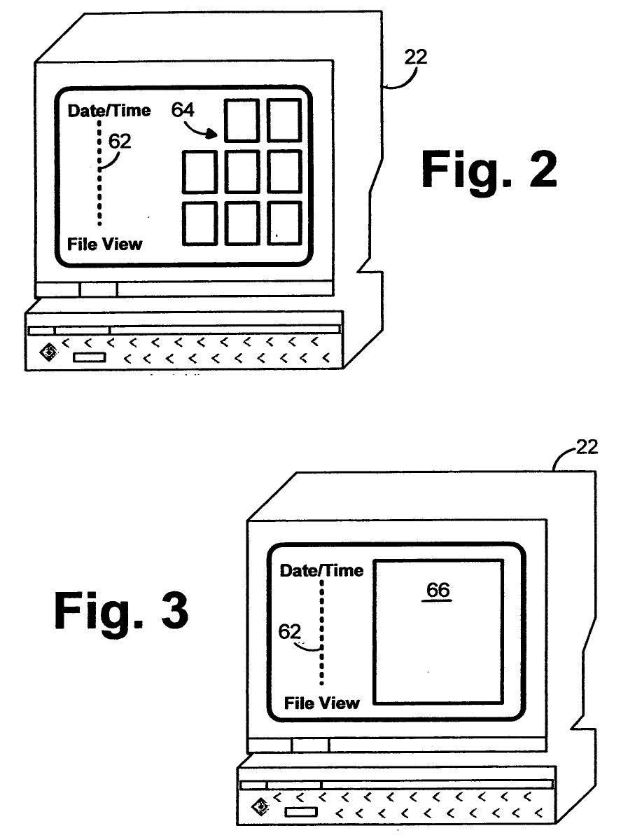

Relational database 32 is shown generally in FIG. 1 and described in detail in connection with the graphical user interfaces, tables and schedules shown in the remaining drawings. The graphical user interfaces display various layouts of data derived from relational database 32 as in FIGS. 2 and 3. As shown, these layouts may take the form of thumbnail views 64, blow-up views 66, or other configurations.

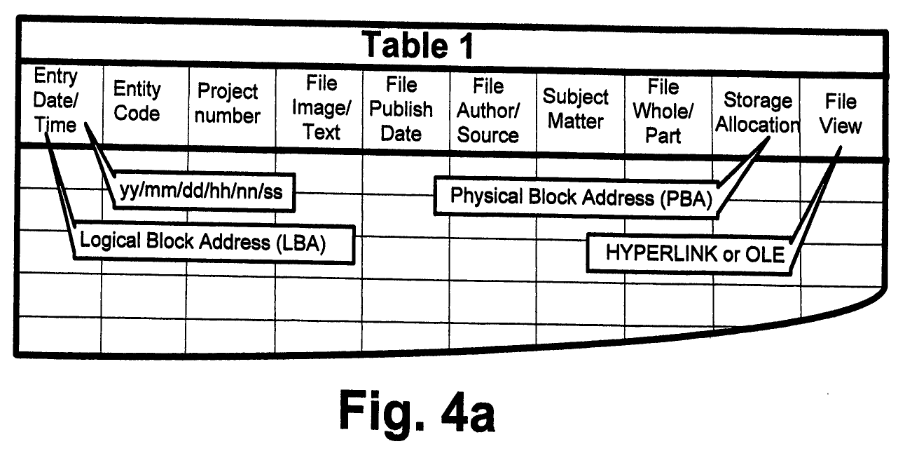

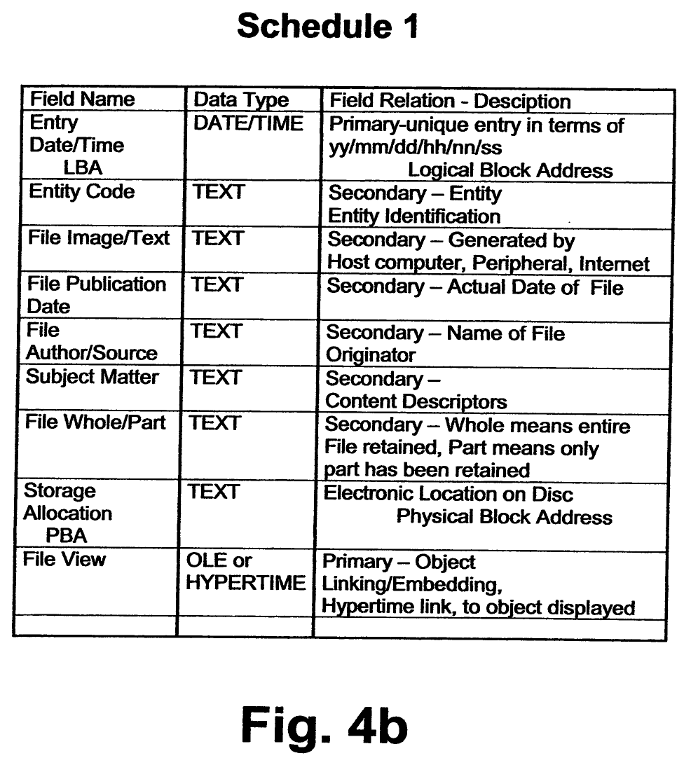

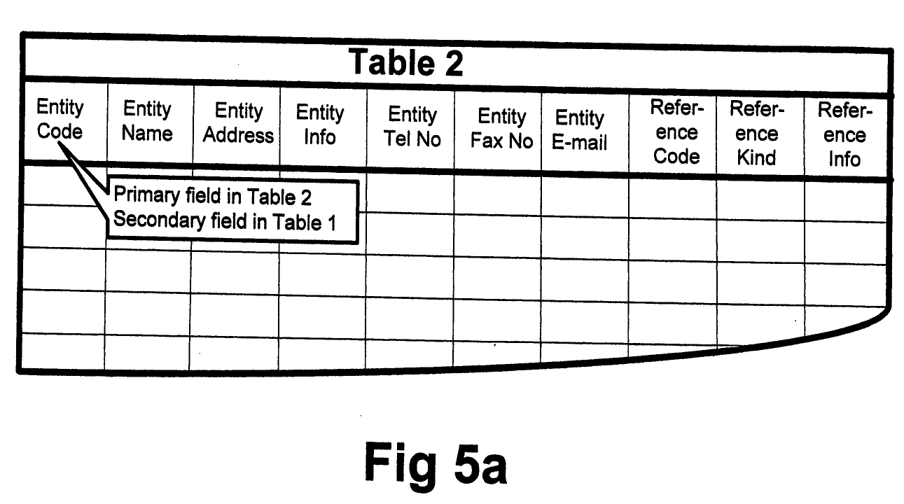

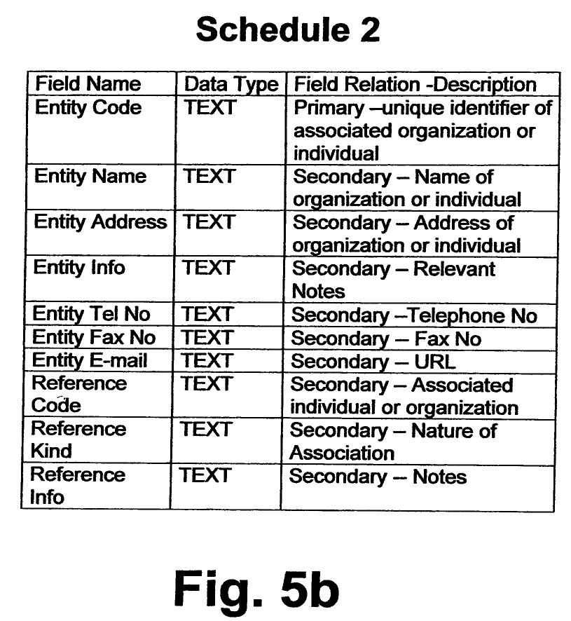

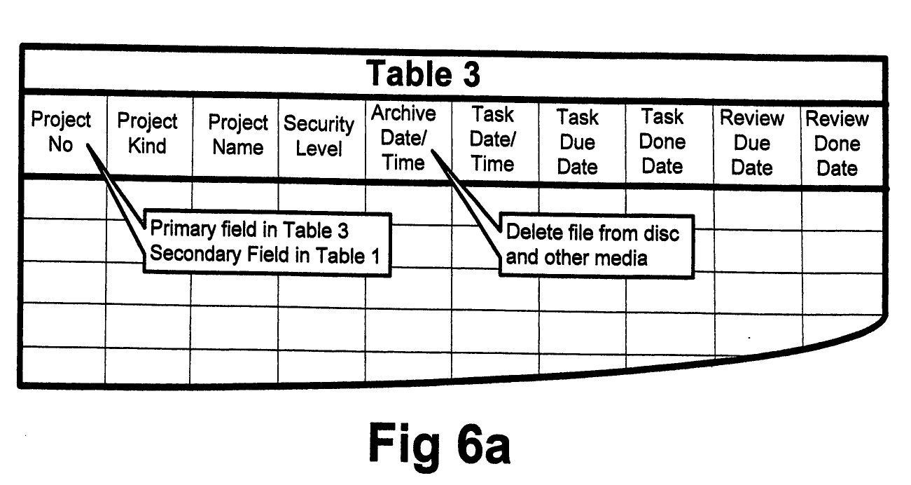

Details of relational database 32 are shown in: Table 1 and Schedule 1 of FIGS. 4a and 4b; Table 2 and Schedule 2 of FIGS. 5a and 5b; and Table 3 and Schedule 3 of FIGS. 6a and 6b. These tables and schedules are based on building blocks provided in software sold by Microsoft Corporation, of Seattle, Wash., U.S.A., under the trademark Microsoft Access (the Access Building Blocks).

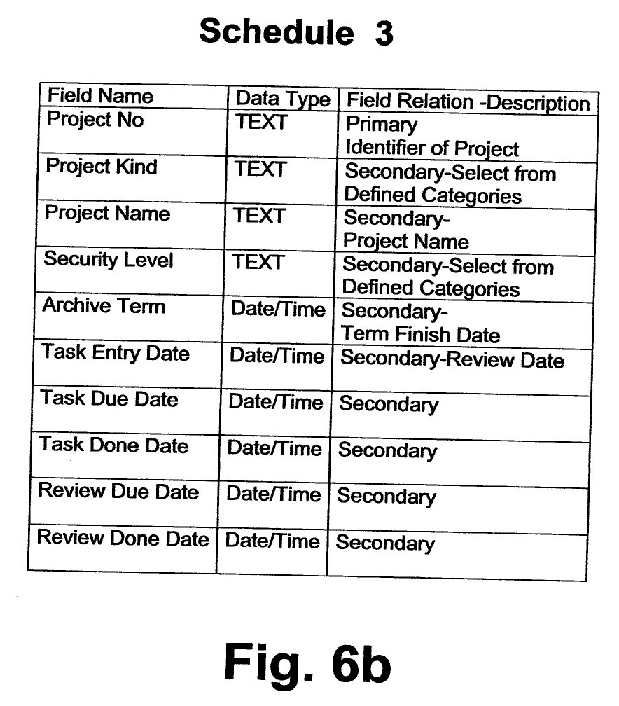

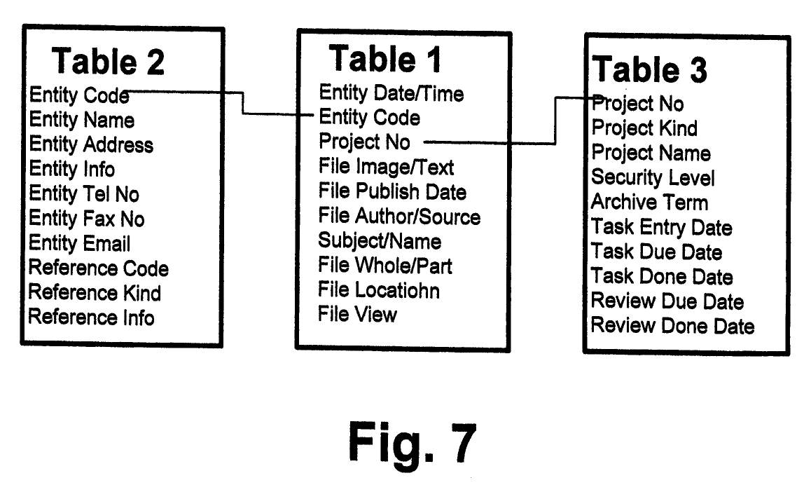

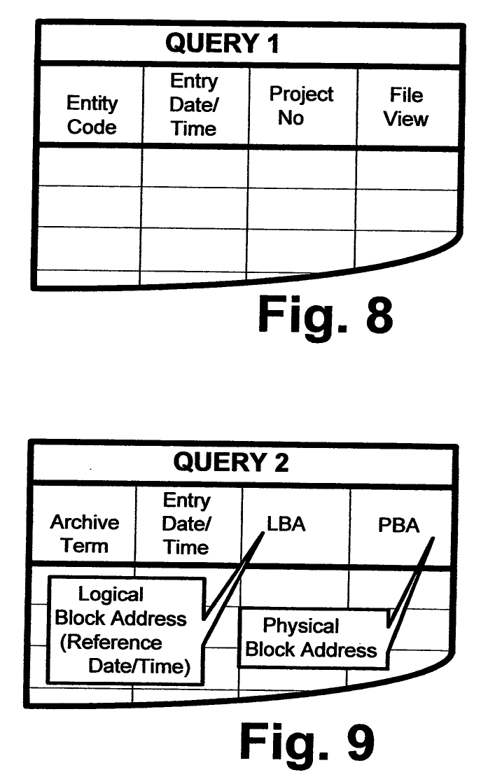

As will be seen in FIG. 7, the following relational links exist among Tables 1, 2 and 3. The Entity_Code (many or secondary) field of Table 1 is linked to the Entity_Code (primary or one) field of Table 2. The Project_No (secondary or many) field of Table 1 is linked to the Project_No (primary or one) field of Table 3. Preferably, a date/time instance value in the Entry_Date/Time field of Table 1 is automatically generated by the system at the date/time of data entry. In one form, this value is in terms of year, month, day,hour, minute, second, and fractions of second, i.e., yy, mm, dd, hh, nn, ss, ff. In another form, this value is in terms of year, month, day, hour, minute and sequential integers, i.e., yy, mm, dd, ii. The timing is arranged so that each electronic record or file is uniquely identified at the real time of its acquisition or creation by entry of a date/time instance or a date/time instance that includes an additional alphanumeric character or characters for further identification. This date time instance, or a reference to it, constitutes a logical block address (LBA) as described above.

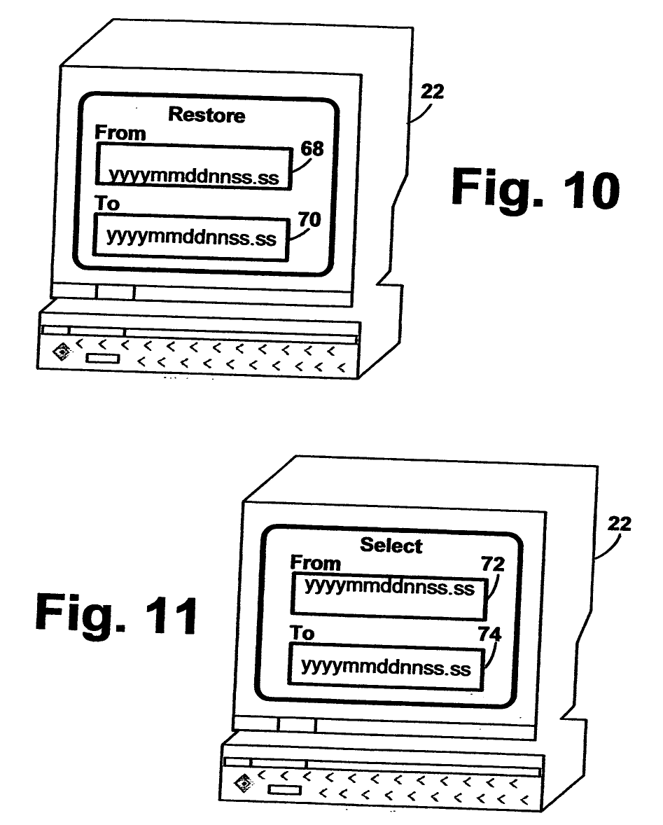

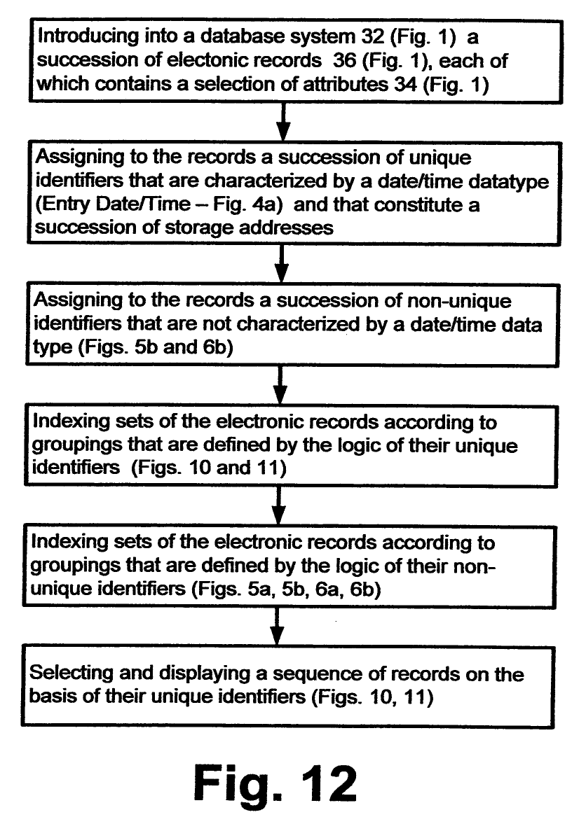

As shown in FIG. 10, the graphical user interface presents a control window, by which a range of entries in the database system, shown between 68 and 70, may be restored when corruption of data or malfunction of hardware has occured outside of the range. When such corruption or malfunction occurs at a particular time in workstation 22, a transfer of valid data from storage 24 to workstation 22 can be effected. As shown in FIG. 11, the graphical user interface presents a control window, by which any range of entries within the boundaries of a range, as shown between reference numerals 72 and 74, may be selected for retention or destruction pursuant to a predefined archival schedule. In either case, data fragmentation is minimized because the logical continuity of selected date/time instances ensures the physical contiguity of corresponding sequences of physical storage blocks 54, and consequent minimal seek time during data retrieval.

An exemplary process of the present invention is depicted in FIG. 12 as comprising steps, which are performed in host and auxiliary systems that are operatively connected. Each of the systems comprises a stack of spinning magnetic discs, each of which is characterized by so-called “block” locations at the intersections of concentric tracks and radial sectors for the reception and transmission of electronic records by interaction with a transducer that swings across the spinning magnetic discs. PBA's (physical block addresses), which are specified at these intersections, correspond to LBA's (logical block addresses), which contain data that can be processed in a computer system.

### OPERATION

In the present invention, a relational database is implemented in a block storage system, in which logical block allocation is based on real time entry of data in a sequence of date time instances. The database contains a set of electronic files that are characterized by the following sets (fields) of attributes. One of the sets (fields) is a succession of unique identifiers that are characterized by a date/time data type and designate a succession of storage block addresses. At least another of the sets (fields) is a succession of non-unique identifiers that are not characterized by a date/time data type. Certain sets of the electronic files are indexed according to groupings that are defined by the logic of the unique identifiers. Other sets of the electronic files are indexed according to groupings that are defined by the logic of the non-unique identifiers.

1. A digital computer system comprising an input/output, a controller, a display, and a block storage, said storage comprising:
(a) at least a stack of rotatable magnetic discs having thereon block locations at physical intersections of concentric circular tracks and radial sectors;
(b) at least an assemblage of transducers that are constrained by a servo for movement across faces of said discs to receive and transmit electronic signals representing records in said block locations;
(c) relationships with said physical intersections determining physical block addresses of the block locations;
(d) logical block addresses corresponding to said physical block addresses and having a data-type format that is capable of being processed by said controller;
(e) said logical block addresses representing a relational database configuration of cells, which are defined at logical intersections of a sequence of rows that specify a sequence of records, and a sequence of columns that specify a sequence of attributes;
(f) one of said columns defining a selected attribute of a selected record as a unique identifier of said selected record, said unique identifier representing the date/time instance of entry of said selected record into said database system;
(g) other columns defining other attributes in said selected record;
(h) a succession of records corresponding to a succession of date/time instances of entry thereof into said database system.

2. The digital computer system of claim 1, wherein said records are e-mail records.

3. The digital computer system of claim 1, wherein said records are image records.

4. The digital computer system of claim 1, wherein said records are computer generated records.

5. The digital computer system of claim 1, wherein said succession of records correspond to a succession of block locations that are contiguous.

6. The digital computer system of claim 1, wherein at least one of said columns specifies the termination date of an archival period.

7. The digital computer system of claim 1, wherein said unique identifier specifies seconds.

8. The digital computer system of claim 1, wherein said display specifies a range of unique identifiers in a format that includes second in its date/time value.

9. The digital computer system of claim 1, wherein logical block addresses are specified by said unique identifiers.

10. A process performed on (A) a digital computer system, which is (B) programmed with a relational database:
(A) said computer comprising an input/output, a controller, a display, and a block storage, said storage comprising at least a stack of rotatable magnetic discs having thereon block locations at physical intersections of concentric circular tracks and radial sectors, and at least an assemblage of transducers that are constrained by a servo for movement across faces of said discs to receive and transmit electronic signals representing records in said block locations;
(B) said relational database comprising a configuration of cells, which are defined at logical intersections of a sequence of rows that specify a sequence of records, and a sequence of columns that specify a sequence of attributes;
(C) said process comprising the steps of:
(1) establishing physical block addresses of said block locations by determining their relationships to said physical intersections;
(2) establishing logical block addresses corresponding to said physical block addresses by reference to a date/time data-type format that is capable of being processed by said controller;
(3) defining one of said columns as an attribute referring to a unique identifier representing the date/time instance of entry of a selected record into said database system;
(4) defining other columns as other attributes in said selected record; and
(5) establishing a succession of said unique identifiers in a succession of said records in correspondence with a succession of date/time instances of entry thereof into said database system.

11. The process of claim 10 including the step of establishing in certain of said rows attributes that represent e-mail records.

12. The process of claim 10 including the step of establishing in certain of said rows attributes that represent image records.

13. The process of claim 10 including the step of establishing in certain of said rows attributes that represent computer generated records.

14. The process of claim 10 including the steps of establishing in certain of said rows records that correspond to a succession of block locations that are contiguous.

15. The process of claim 10 including the step of defining at least one of said columns to refer to the termination date of an archival period.

16. The process of claim 10 including defining said unique identifier in terms that specify seconds.

17. The process of claim 10 including presenting on said display range of unique identifiers in a format that includes second in its date/time value.

18. The process of claim 10 including the step of specifying logical block addresses in terms of said unique identifiers.

19. A computer system comprising a host computer system and an auxilliary computer system, each of said host computer system and said auxilliary system including an input/output, a controller, a display, and a storage, said storage comprising:
(a) at least a stack of rotatable magnetic discs having thereon block locations at physical intersections of concentric circular tracks and radial sectors;
(b) at least an assemblage of transducers that are constrained by a servo for movement across faces of said discs to receive and transmit electronic signals representing records in said block locations;
(c) physical block addresses of said block locations being based on relationships with said physical intersections;
(d) logical block addresses corresponding to said physical block addresses and having a data-type format that is capable of being processed by said controller;
(e) said logical block addresses representing a relational database configuration of cells, which are defined at logical intersections of a sequence of rows that specify a sequence of records, and a sequence of columns that specify a sequence of attributes;
(f) one of said columns defining a selected attribute of a selected record as a unique identifier of said selected record, said unique identifier representing the date/time instance of entry of said selected record into said database system;
(g) other columns defining other attributes in said selected record;
(h) a succession of records corresponding to a succession of date/time instances of entry thereof into said database system.
(i) said host computer system and said auxilliary computer system being programmed to maintain substantially identical databases substantially in real time.

20. A digital computer system comprising an input/output, a controller, a display, and a block storage, said storage comprising:
(a) at least a stack of rotatable magnetic discs having thereon block locations at physical intersections of concentric circular tracks and radial sectors;
(b) at least an assemblage of transducers that are constrained by a servo for movement across faces of said discs to receive and transmit electronic signals representing records in said block locations;
(c) relationships with said physical intersections determining physical block addresses of the block locations;
(d) logical block addresses corresponding to said physical block addresses and having a data-type format that is capable of being processed by said controller;
(e) said logical block addresses representing a relational database configuration of cells, which are defined at logical intersections of a sequence of rows that specify a sequence of records, and a sequence of columns that specify a sequence of attributes;
(f) one of said columns defining a selected attribute of a selected record as a unique identifier of said selected record, said unique identifier representing the date/time instance of entry of said selected record into said database system;
(g) other columns defining other attributes in said selected record;
(h) a succession of records constituting a succession of electronic files characterized by date/time instances of entry thereof into said database system.

21. A computer system comprising a host computer system and a backup computer system, said host computer system including a host input/output, a host controller, a host display, and a host storage, said backup computer system including a backup input/output, a backup controller, a backup display, and a backup storage, said host storage and said backup storage each comprising:
(a) at least a stack of rotatable magnetic discs having thereon block locations at physical intersections of concentric circular tracks and radial sectors;
(b) at least an assemblage of transducers that are constrained by a servo for movement across faces of said discs to receive and transmit electronic signals representing records in said block locations;
(c) physical block addresses of said block locations being based on relationships with said physical intersections;
(d) logical block addresses corresponding to said physical block addresses and having a data-type format that is capable of being processed by said controller;
(e) said logical block addresses representing a relational database configuration of cells, which are defined at logical intersections of a sequence of rows that specify a sequence of records, and a sequence of columns that specify a sequence of attributes;
(f) one of said columns defining a selected attribute of a selected record as a unique identifier of said selected record, said unique identifier representing the date/time instance of entry of said selected record into said database system;
(g) other columns defining other attributes in said selected record;
(h) a succession of records corresponding to a succession of date/time instances of entry thereof into said database system;
(i) said host input/output receiving external signals representing sequential records;
(k) said host controller entering sequential records corresponding to said external signals in real time in sequential rows of said database of said host computer and sending signals in real time corresponding to said external signals to said backup controller;
(l) said backup controller entering sequential records corresponding to said external signals in real time in sequential rows of said database of said backup computer.

22. A computer system comprising (1) a host computer system including a plurality of workstations, and (2) a backup computer system, each of said workstations including a host input/output, a host controller, a host display, and a host storage, said backup computer system including a backup input/output, a backup controller, a backup display, and a backup storage, each said host storage and said backup storage comprising:
(a) at least a stack of rotatable magnetic discs having thereon block locations at physical intersections of concentric circular tracks and radial sectors;
(b) at least an assemblage of transducers that are constrained by a servo for movement across faces of said discs to receive and transmit electronic signals representing records in said block locations;
(c) physical block addresses of said block locations being based on relationships with said physical intersections;
(d) logical block addresses corresponding to said physical block addresses and having a data-type format that is capable of being processed by said controller;
(e) said logical block addresses representing a relational database configuration of cells, which are defined at logical intersections of a sequence of rows that specify a sequence of records, and a sequence of columns that specify a sequence of attributes;
(f) one of said columns defining a selected attribute of a selected record as a unique identifier of said selected record, said unique identifier representing the date/time instance of entry of said selected record into said database system;
(g) other columns defining other attributes in said selected record;
(h) a succession of records corresponding to a succession of date/time instances of entry thereof into said database system;
(i) said host input/output receiving external signals representing sequential records;
(k) said host controller entering sequential records corresponding to said external signals in real time in sequential rows of said database of said host computer and sending signals in real time corresponding to said external signals to said backup controller;
(l) said backup controller entering sequential records corresponding to said external signals in real time in sequential rows of said database of said backup computer;
(m) said sequential records of each said host workstation and said sequential records of said backup computer constituting electronic files.
